(19) United States
(12) Patent Application Publication
(10) Pub. No.: US 2007/0146439 A1
(43) Pub. Date: Jun. 28, 2007

(54) SURFACE ACOUSTIC WAVE DRIVEN FLUID INJECTION DEVICES

(75) Inventors: Chung Cheng Chou, Taoyuan County (TW); Chih Ming Lin, Taichung City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/567,087

(22) Filed: Dec. 5, 2006

(30) Foreign Application Priority Data
Dec. 8, 2005 (TW) TW94143336

(51) Int. Cl. B41J 2/045

(52) U.S. Cl. 347/68

(57) ABSTRACT

A surface acoustic wave driven fluid injection device. A substrate is provided. A channel is disposed in the substrate along a first direction containing a fluid which has an exposed surface. A first slanted fingers inter-digital transducer is disposed on one side of the channel of the substrate, wherein the first slanted fingers inter-digital transducer comprises a plurality of slanted inter-digital electrodes, and wherein the width and interval of the slanted inter-digital electrodes at one end are greater than the width and interval of the slanted inter-digital electrodes at the other end, thereby providing continuous surface acoustic wave with multiple frequencies.

### BACKGROUND OF THE INVENTION

1. Field of the Invention

The invention relates to fluid injection devices, and more particularly, to surface acoustic wave driven fluid injection devices using slanted fingers inter-digital transducers (SFIT).

2. Description of the Related Art

Fluid injection devices have long been employed in information technology industries. As micro-system engineering technologies have developed, fluid injection devices have typically been applied in inkjet printers, fuel injection systems, cell sorting systems, drug delivery systems, print lithography systems and micro-jet propulsion systems. Among inkjet printers presently known and used, fluid injection devices can mainly be divided into two categories, continuous mode and drop-on-demand mode.

According to the driving mechanism, conventional fluid injection devices can further be divided into thermal bubble driven and piezoelectric diaphragm driven fluid injection devices. Of the two, thermal driven bubble injection has been most successful due to its reliability, simplicity and relatively low cost.

Thermal bubble driven fluid injection devices, however, are not applicable for biotechnologies due to thermal decomposition. Thus, piezoelectric diaphragm driven fluid injection devices are more suitable for biotechnology applications. Moreover, the piezoelectric diaphragm driven fluid injection devices can be used to image printer because of its fast response, precise actuation; furthermore, it can be capable of injecting droplets with high viscosity or polymer droplets.

U.S. Pat. Nos. 5,063,396 and 5,179,394, the entirety of which are hereby incorporated by reference, disclose an inter-digital transducer (IDT) fabricated on the piezoelectric materials which could generate surface acoustic waves (SAW). Since the streaming force existing between the ink and the substrate can result in vibration on the ink surface, ink droplets can be ejected due to energetic vibration. Further, the ink droplet injection can be controlled by adjusting the frequencies of alternating current (AC) signals to achieve multi-color level images. Moreover, ink droplets can be directly injected from the ink surface so the productivity could be increased and the cost could be reduced because of the lack of the alignment of a conventional nozzle plate during fabrication processes.

FIG. 1 is a schematic view of a conventional surface acoustic wave (SAW) driven fluid injection device. A fluid injection device 10 comprises an IDT 2 to generate the surface acoustic wave for fluid injection. When the fluid injection device 10 is driven by a single IDT 2, an additional comb-shaped electrode is required to serve as a switch to determine whether the surface acoustic wave would be passed or inhibited according to our printing demands.

Furthermore, U.S. Pat. No. 6,955,416, the entirety of which is hereby incorporated by reference, discloses a surface acoustic wave driven fluid injection device using a quasi-switch as a controller. Surface acoustic wave amplifiers 18a-18f are disposed between inter-digital transducers 11a-11d and nozzles 12a-12c. The amplitude of the surface acoustic wave generated by inter-digital transducers 11a-11d can be controlled by surface acoustic wave amplifiers 18a-18f according to predetermined printing demands.

FIG. 2 is a schematic view of another conventional surface acoustic wave (SAW) driven fluid injection device. A conventional fluid injection device 20 includes a driver 15, a surface acoustic wave device 10, inter-digital transducers 11a-11d, ink droplet injectors 12a-12c, ink reservoirs 13a-13c, surface acoustic wave damping materials 14a-14b, and surface acoustic wave amplifiers 18a-18f. The conventional fluid injection device 20, however, requires an additional quasi-switch as a controller, thus resulting in intricate fluid injection devices and increasing production cost.

### BRIEF SUMMARY OF THE INVENTION

Accordingly, the invention is directed to surface acoustic wave driven fluid injection devices. A slanted fingers inter-digital transducer (SFIT) is integrated with a fluid injection device to provide broadband surface acoustic wave (SAW) driven multi-droplet injection at different locations and flight direction simultaneously.

The invention provides a SAW driven fluid injection device, comprising a substrate; a channel disposed on the substrate along a first direction containing the fluid which has an exposed surface; and a first slanted fingers inter-digital transducer disposed on one side of the channel on the substrate, wherein the first slanted fingers inter-digital transducer comprises a plurality of slanted inter-digital electrodes, and wherein the width and interval of the slanted inter-digital electrodes at one end are greater than the width and interval of the slanted inter-digital electrodes at the other end, thereby providing continuous surface acoustic wave with multiple frequencies.

The invention further provides a SAW driven fluid injection. device, comprising: a piezoelectric substrate; a channel disposed on the substrate along a first direction containing the fluid which has an exposed surface; a first slanted fingers inter-digital transducer disposed on one side of the channel of the substrate; and a second slanted fingers inter-digital transducer disposed on the other side of the channel of the substrate, wherein the first slanted inter-digital transducer comprises a plurality of slanted inter-digital electrodes, and wherein the width and interval of the slanted inter-digital electrodes at one end are greater than the width and interval of the slanted inter-digital electrodes at the other end, thereby providing continuous surface acoustic wave with multiple frequencies, and wherein the second slanted fingers inter-digital transducer comprises a plurality of slanted inter-digital electrodes, and wherein the width and interval of the slanted inter-digital electrodes at one end are greater than the width and interval of the slanted inter-digital electrodes at the other end, thereby providing continuous surface acoustic wave with multiple frequencies.

### BRIEF DESCRIPTION OF THE DRAWINGS

The invention can be more fully understood by reading the subsequent detailed description and examples with references made to the accompanying drawings, wherein:

FIG. 1 is a schematic view of a conventional surface acoustic wave (SAW) driven fluid injection device;

FIG. 2 is a schematic view of another conventional surface acoustic wave (SAW) driven fluid injection device;

FIG. 3A is a plan view of a surface acoustic wave device providing a single central frequency;

FIG. 3B shows a frequency response spectrum of the SAW device of FIG. 3A;

FIG. 4A is a plan view of a slanted fingers inter-digital transducer (SFIT) SAW device providing multiple frequencies according to an embodiment of the invention;

FIG. 4B shows a frequency response spectrum of the SFIT SAW device of FIG. 4A;

FIG. 5A is a plan view of a SFIT SAW driven fluid injection device according to a first embodiment of the invention;

FIG. 5B is a cross section of the SFIT SAW driven fluid injection device of FIG. 5A taken along line I-I;

FIG. 6A is a plan view of an exemplary embodiment of a SFIT SAW driven fluid injection device;

FIG. 6B is a cross section of the SAW driven fluid injection device of FIG. 6A taken along line II-II;

FIG. 7A is a plan view of a SFIT SAW driven fluid injection device according to a second embodiment of the invention;

FIGS. 7B-7D are the cross sections of the SFIT SAW driven fluid injection device of FIG. 7A taken along line III-III;

FIG. 8A is a plan view of a SFIT SAW driven fluid injection device according to a third embodiment of the invention;

FIG. 8B is a cross sections of the SFIT SAW driven fluid injection device of FIG. 8A taken along line IV-IV;

FIG. 9 is a cross sections of the SFIT SAW driven fluid injection device on a piezoelectric layer depositing on a substrate;

FIG. 10 is a schematic view illustrating relationship among the velocity of surface acoustic wave on the substrate V_{solid}, the velocity of surface acoustic wave on the fluid V_{liquid}, and the flight angle of fluid droplet θ; and

FIG. 11 shows an exemplary embodiment of a frequency response spectrum of the SFIT SAW driven fluid injection device.

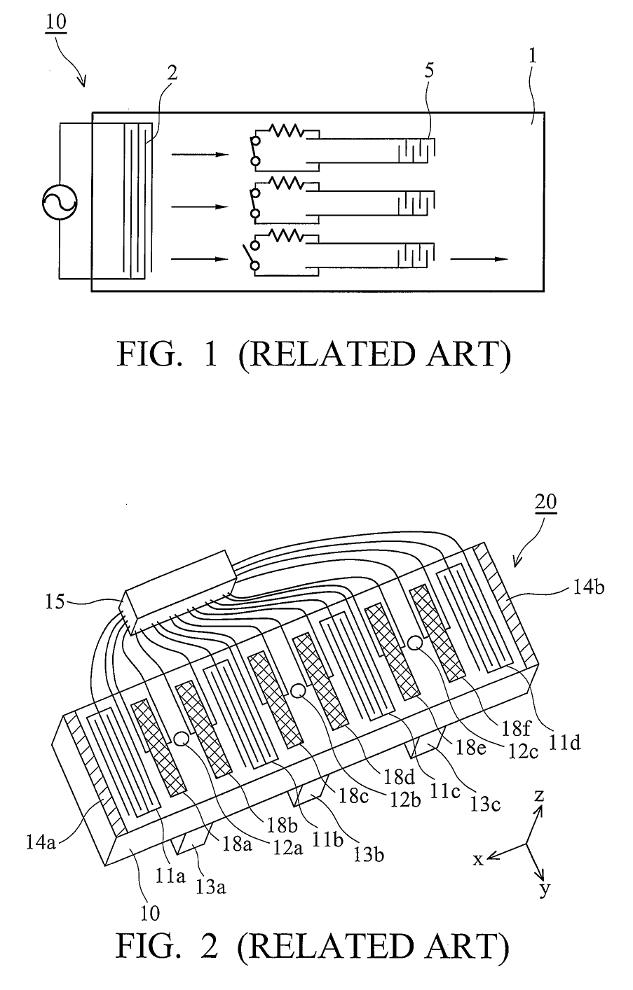

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a surface acoustic wave driven fluid injection device comprising slanted fingers inter-digital transducers (SFIT) that could generate a broadband surface acoustic wave (SAW) to eject ink droplets. Further, this driven fluid injection device can eject fluid droplets with or without nozzle plate thereon. That is to say, it is easy to control the locations of ejected ink droplets on the paper surface by changing frequencies of the AC signals. Therefore, this SFIT SAW driven fluid injection device can render multi-color level images. Moreover, fluid droplets can be directly injected from the fluid surface without additional nozzle plates and switches.

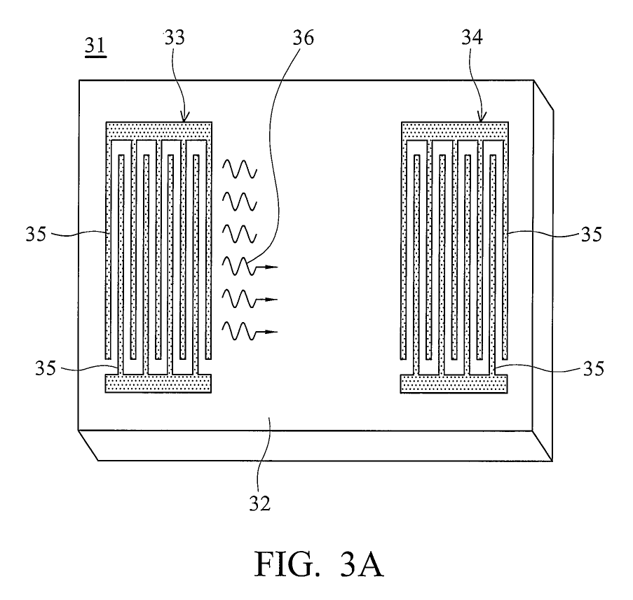

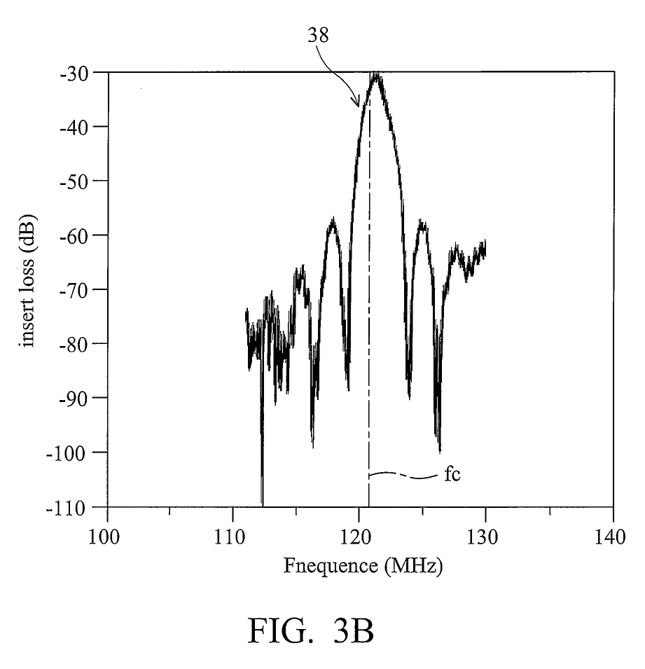

FIG. 3A is a plan view of a surface acoustic wave device providing a single central frequency. FIG. 3B shows a frequency response spectrum of the SAW device of FIG. 3A. Referring to FIG. 3A, a conventional SAW device 31 comprises a piezoelectric substrate 32, a surface acoustic wave transmitter 33 and a surface acoustic wave receiver 34 thereon. The surface acoustic wave transmitter 33 and surface acoustic wave receiver 34 comprise uniform inter-digital electrodes 35 or comb-shaped electrodes. Since the uniform inter-digital electrodes 35 has a specific line width, the surface acoustic wave transmitter 33 transmits a single central frequency surface acoustic wave 36 received by the surface acoustic wave receiver 34. A frequency response spectrum 38 with the single central frequency f_{c} is shown in FIG. 3B. Since the bandwidth of the response frequency is approximately 0.5 MHz, fluid droplets only can be ejected at a single location.

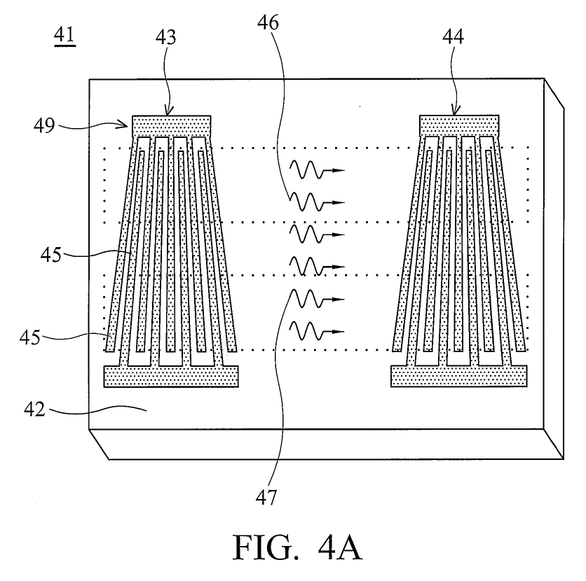

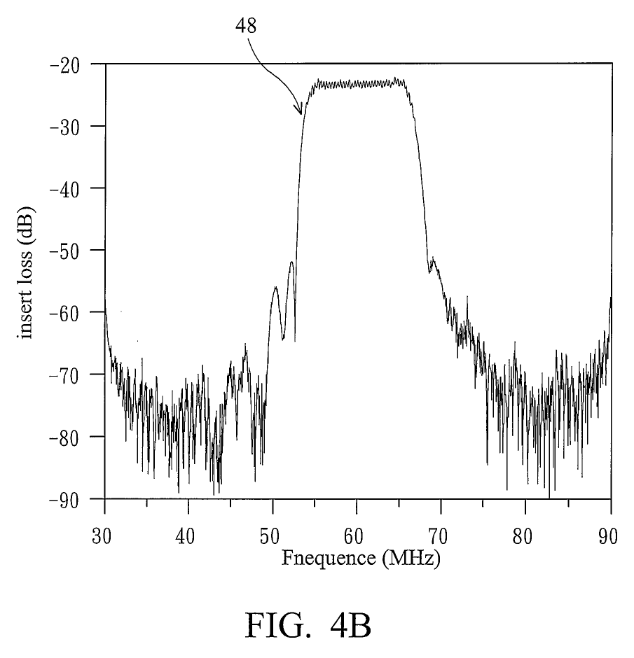

FIG. 4 is a plan view of a slanted fingers inter-digital transducer (SFIT) SAW device providing multiple frequencies according to an embodiment of the invention. FIG. 4B shows a frequency response spectrum of the SFIT SAW device of FIG. 4A. Referring to FIG. 4A, a SFIT SAW device 41 comprises a piezoelectric substrate 42, a SFIT surface acoustic wave transmitter 43 and a SFIT surface acoustic wave receiver 44 thereon. The SFIT surface acoustic wave transmitter 43 and receiver 44 comprise slanted inter-digital electrodes 45 or slanted comb-shaped electrodes. The slanted inter-digital electrodes 45 preferably have continuously varied line widths and intervals. The line width and interval are equal along propagation route of the surface acoustic wave. The SFIT surface acoustic wave transmitter 43 transmits multiple acoustic wave frequencies received by the SFIT surface acoustic wave receiver 44, thereby generating a broadband frequency response, spectrum 48, as shown in FIG. 4A.

The SFIT surface acoustic wave transmitter 43 comprises a plurality of slanted inter-digital electrodes 45 with continuously varied line widths and intervals. Each electrode 45 is staggered with one end connecting a bus bar 49 and the other end connecting another bus bar. The longitudinal axis of each electrode 45 is not perpendicular to the bus bar 49. The bus bar 45 can be connected to an AC signal source (not shown) while the other bus bar can be grounded. The AC signal source comprising an alternating current source can generate an electrical potential between bus bar; that is, an electrical potential exists between the slanted inter-digital electrodes 45. When the AC signal source provides an electrical potential between the slanted inter-digital electrodes 45, a surface acoustic wave with a specific broad bandwidth is created on the surface of the piezoelectric substrate 42. The surface acoustic wave propagates along the surface of the piezoelectric substrate 42 and received by the SFIT surface acoustic wave receiver 44. An electronic signal is transferred by an external electric circuit.

According to a preferred embodiment of the invention, the central frequency f_{c} of the surface acoustic wave generated by the SFIT surface acoustic wave transmitter 43 is approximately 60 MHz. The velocity of surface acoustic wave is supposed to 3488 m/s. The minimum line width and interval of the slanted inter-digital electrodes 45 are approximately 12.4 μm extending to their maximum line width and interval of about 16.6 μm. The SFIT surface acoustic wave transmitter 43 preferably comprises 30 pairs of slanted inter-digital electrodes 45. The SFJT surface acoustic wave receiver 44 preferably comprises 20 pairs of slanted inter-digital electrodes 45. The aperture length of the slanted inter-digital electrodes is approximately 2000 μm.

Referring to FIG. 4B, since the bandwidth of the response frequency is approximately 12 MHz, several fluid droplets with different dimensions can be ejected simultaneously. In FIG. 4A, the surface acoustic wave with higher frequency is propagated along region 46 with more dense electrode arrangements; the surface acoustic wave with lower frequency is propagated along region 47 with less dense electrode arrangements. Therefore, the frequencies and propagation routes of surface acoustic waves are dependent on the frequency of the AC signal source connected to the SFIT surface acoustic wave transmitter 43. That is, multiple fluid droplets can be ejected at different positions by controlling the AC signal source connected to the SFIT surface acoustic wave transmitter 43.

The preferred embodiments of the invention will be described with reference to the attached drawings. For explanation and comparison purposes, we describe the following three embodiments using surface acoustic wave driven fluid injection device as examples.

### Embodiment 1

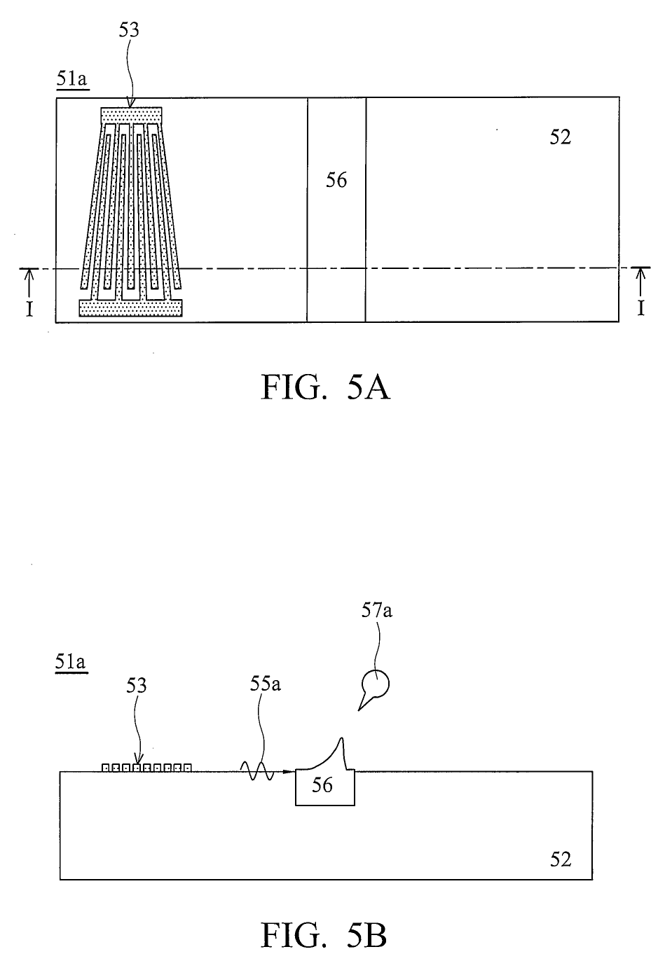

FIG. 5A is a plan view of a SFIT SAW driven fluid injection device according to a first embodiment of the invention. FIG. 5B is a cross section of the SFIT SAW driven fluid injection device of FIG. 5A taken along line I-I. Referring to FIG. 5A, a fluid injection device 51a comprises a slanted fingers inter-digital transducer 53 disposed on the piezoelectric substrate 52. The slanted fingers inter-digital transducer 53 can generate surface acoustic waves 55a to inject the droplet 57a. Injection by the slanted fingers inter-digital transducer 53 depends on the pairs of the slanted inter-digital electrodes, the line width and interval of the slanted inter-digital electrodes, the aperture length of the slanted inter-digital electrodes, or piezoelectric coefficient of the piezoelectric substrate 52. When a desirable bandwidth of the surface acoustic wave is designed, AC signals with different frequencies are input to inject fluid droplets at the corresponding locations. In a preferred embodiment of the invention, a channel 56 can be formed on the piezoelectric substrate 52 by an etching process or a precision mechanic process.

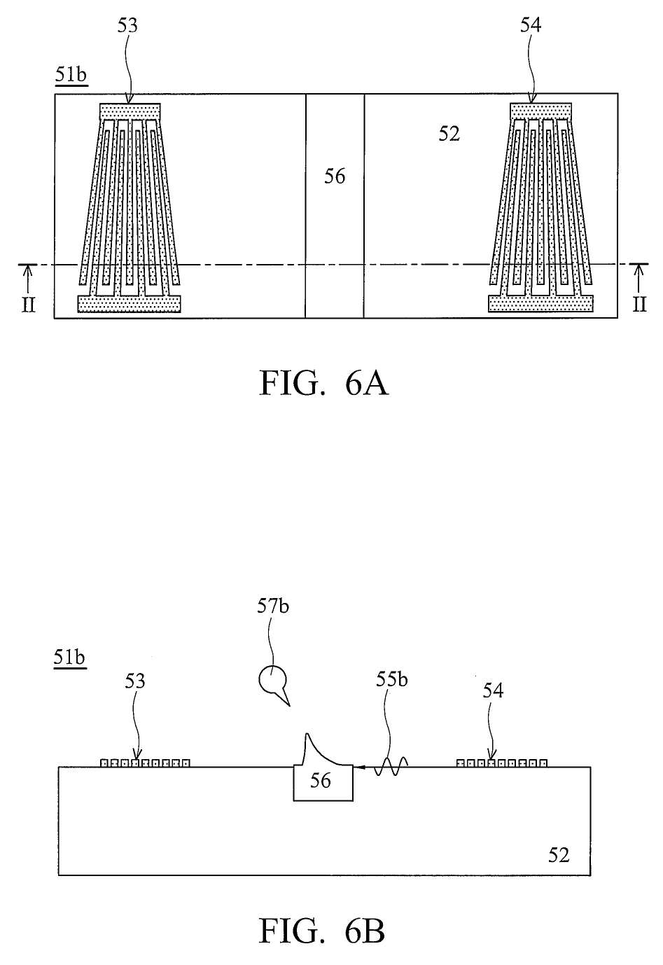

FIG. 6A is a plan view of an exemplary embodiment of a SFIT SAW driven fluid injection device. FIG. 6B is a cross section of the SFIT SAW driven fluid injection device of FIG. 6A taken along line II-II. Referring to FIG. 6A, a SFIT SAW driven fluid injection device 51b comprises two slanted fingers inter-digital transducers 53 and 54 disposed on the surface of piezoelectric substrate 52. The slanted fingers inter-digital transducer 54 can generate surface acoustic waves 55b to inject the droplet 57b. The trajectory of the ejected droplet 57b can be changed and controlled by adjusting input AC signal of one of the slanted fingers inter-digital transducers 53 and 54. More specifically, fluid droplets at different locations can be simultaneously injected to different directions by driving the slanted fingers inter-digital transducers 53 or 54 with different amplitudes and frequencies of AC signals.

According to preferred embodiments of the invention, the piezoelectric substrate 52 comprises quartz, AlN, ZnO, LiNbO₃, Pb(ZrₓTi₁₋ₓ)O₃, or other piezoelectric materials. The electrodes of slanted fingers inter-digital transducers 53 and 54 comprise a patterned metal layer such as aluminum (Al) or gold (Au) formed on the surface of the piezoelectric substrate 52.

### Embodiment 2

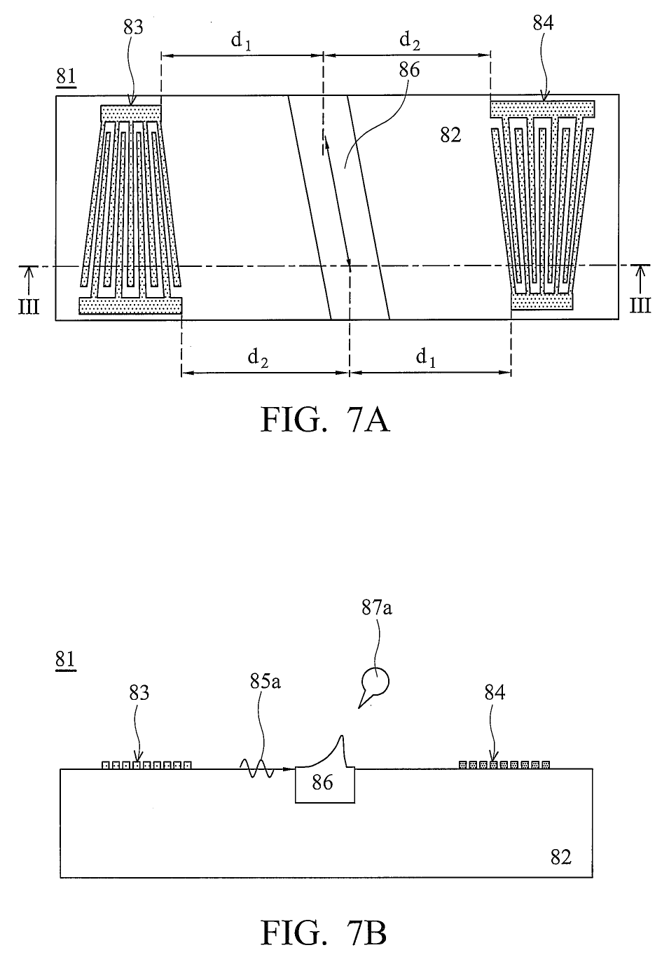

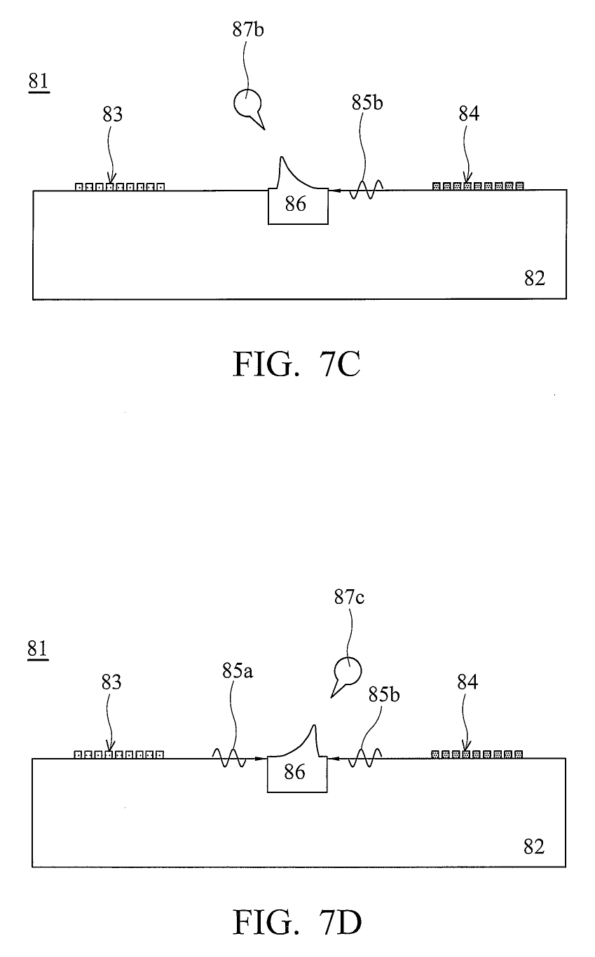

FIG. 7A is a plan view of a SFIT SAW driven fluid injection device according to a second embodiment of the invention. FIGS. 7B-7D are cross sections of the SFIT SAW driven fluid injection device of FIG. 7A taken along line III-III. Referring to FIG. 7A, a SFIT SAW driven fluid injection device 81 comprises two slanted fingers inter-digital transducers 83 and 84 disposed on the surface of the piezoelectric substrate 82. The slanted fingers inter-digital wave transducers 83 and 84 are arranged in opposite direction generating opposite direction surface acoustic waves 85a and 85b to inject droplets 87a, 87b, or 87c. The slanted fingers inter-digital transducers 83 and 84 are designed with identical parameters. In order to let surface acoustic waves 85a and 85b reach the channel 86 simultaneously, the channel 86 is preferably a slanted structure. The distance dl between the narrower electrode end of the slanted fingers inter-digital transducer 83 and the channel 86 equals the distance d2 between the wider electrode end of the slanted fingers inter-digital transducer 84 and the channel 86. Since the propagation distances d1 and d2 of the surface acoustic waves 85a and 85b are equal, fluid droplets 87a, 87b, and 87c can be injected simultaneously.

Referring to FIG. 7B, when an AC signal is applying to the left slanted fingers inter-digital transducer 83, the droplet 87a is ejected in the upper-right direction. On the contrary, when an AC signal is applied to the right slanted fingers inter-digital transducer 84, the droplet 87b is ejected in the upper-left direction, as shown in FIG. 7C. Furthermore, when two AC signals are simultaneously applied to the slanted fingers inter-digital transducers 83 and 84 respectively, the droplet 87c is ejected in a specific direction as shown in FIG. 7D.

The invention is advantageous not only in injecting fluid droplets at different locations simultaneously, but also in arbitrarily changing trajectories of fluid droplets.

### Embodiment 3

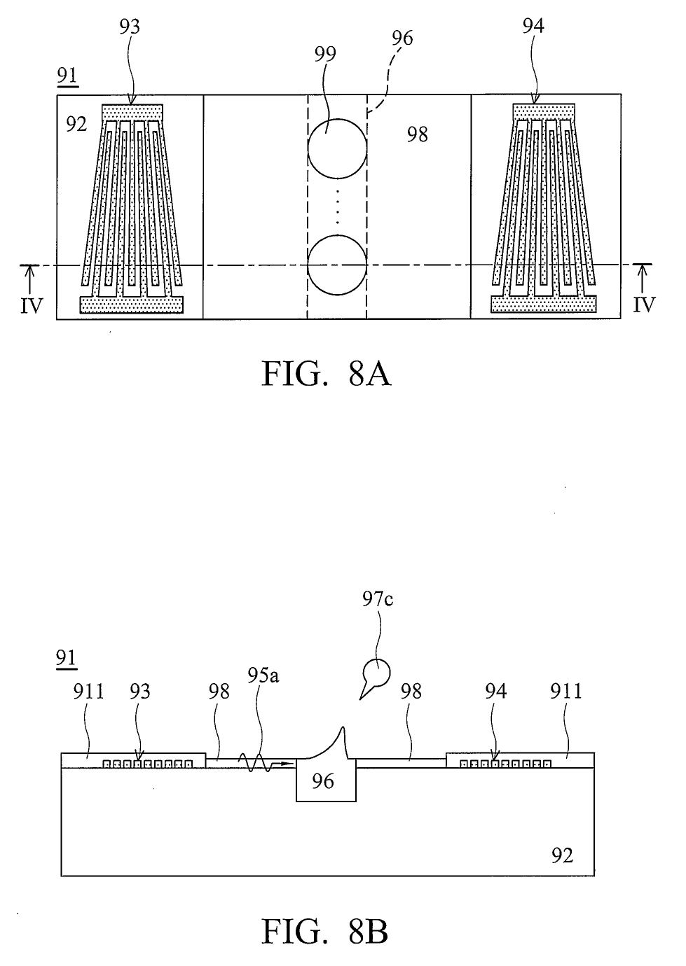

FIG. 8A is a plan view of a SFIT SAW driven fluid injection device according to a third embodiment of the invention. FIG. 8B is a cross sections of the SFIT SAW driven fluid injection device of FIG. 8A taken along line IV-IV. Referring to FIG. 8A, a fluid injection device 91 comprises two slanted fingers inter-digital transducers 93 and 94 disposed on the surface of the piezoelectric substrate 92. A passivation layer 911 is deposited on the slanted fingers inter-digital transducers 93 and 94 by the sputtering or chemical vapor deposition (CVD). The slanted fingers inter-digital transducers 93 generate surface acoustic wave 95a to inject the droplet 97a. A nozzle plate 98 comprising a plurality of nozzles 99 to conduct fluid droplet 97 injection is disposed on the channel 96 of the piezoelectric substrate 92. In a preferred embodiment of the invention, the channel 96 is formed on the piezoelectric substrate 92 by an etching process or a precision mechanic process.

According to preferred embodiments of the invention, the nozzle plate 98 comprises anti-chemical metals as nickel (Ni), gold (Au), or polymers such as a resin dry film, polyimide and so forth. The passivation layer 911 comprises SiO₂, Si₃N₄, or other dielectric materials.

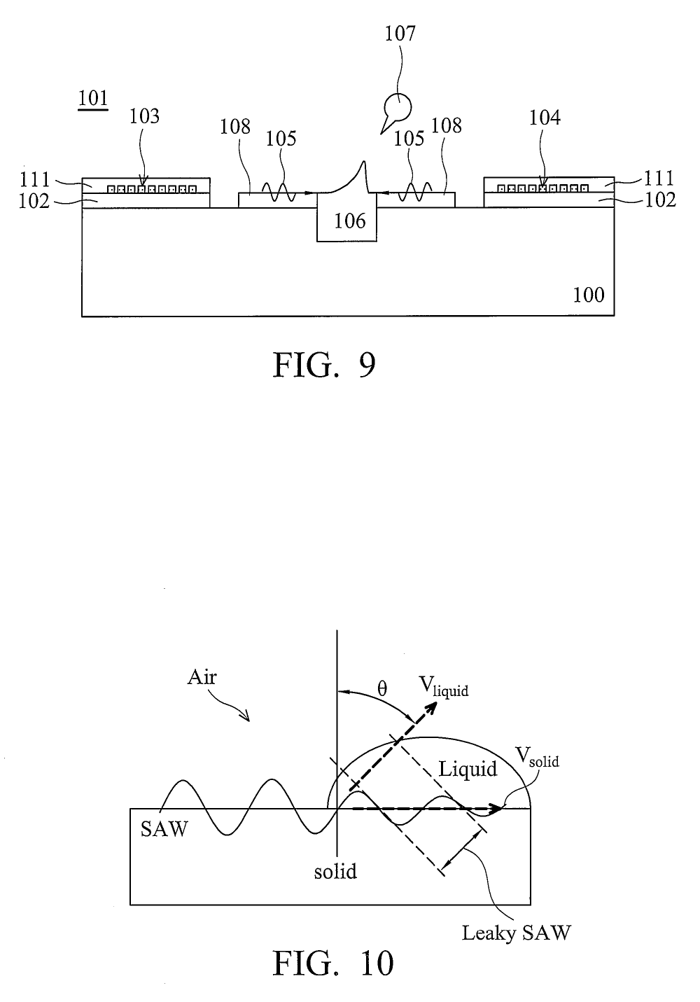

Note that the SFIT SAW driven fluid injection device is disposed on a piezoelectric substrate, but not limited thereto. For example, the SFIT SAW fluid injection device 101 as shown in FIG. 9 can be formed on a piezoelectric layer 102 depositing on a substrate 100. The piezoelectric layer 102 is preferably deposited by sputtering or chemical vapor deposition (CVD). Two slanted fingers inter-digital transducers 103 and 104 are formed on the piezoelectric layer 102 to serve as surface acoustic waves 105 generators to inject fluid droplets 107. A passivation layer 111 is formed on the slanted fingers inter-digital transducers 103 and 104 by sputtering or CVD. A nozzle plate 108 comprising a plurality of nozzles (not shown) to conduct injection of fluid droplets 107 is disposed on the channel 106 of the substrate 100. In a preferred embodiment of the invention, the channel 106 is formed on the substrate 100 by an etching process or a precision mechanical process.

According to preferred embodiments of the invention, the substrate 100 comprises a monocrystalline silicon wafer. The piezoelectric substrate 102 comprises AlN, ZnO, LiNbO₃, LiTaO₃, Pb(ZrₓTi₁₋ₓ)O₃, or other piezoelectric materials. The passivation layer 111 comprises SiO₂, Si₃N₄, or other dielectric materials.

According another embodiment of the invention, the piezoelectric layer 102 can alternatively be disposed between the slanted fingers inter-digital transducers 103, 104 and the substrate 100. The passivation layer 111 covers the slanted fingers inter-digital transducers 103 and 104. Furthermore, the piezoelectric layer 102 can alternatively be formed on the slanted fingers inter-digital transducers 103 and 104. The piezoelectric layer 102 can also serve as a protection layer. A passivation layer 111 can optionally formed on the piezoelectric layer 102.

The slanted fingers inter-digital transducers and the nozzle plate can comprise several configurations. For example, the slanted fingers inter-digital transducers can be disposed on the nozzle plate, or the slanted fingers inter-digital transducers can alternatively be disposed beside the nozzle plate. For simplicity sakes, their detailed description is omitted.

Note that the flight trajectory, direction, and dimensions of fluid droplets driven by surface acoustic wave depend on characteristics of the piezoelectric substrate and the fluid. For example, if the velocity of surface acoustic wave generated by the slanted fingers inter-digital transducers on the substrate or nozzle plate is V_{solid}. The velocity of surface acoustic wave on the fluid is V_{liquid}. The flight angle of fluid droplet, θ or Rayleigh angle θ, relates to V_{solid} and V_{liquid} expressed by the following formula and shown in FIG. 10:
sin θ=V_{liquid}/V_{solid} (1)

The surface acoustic wave on the substrate is supposed to approximately 3000-4000 m/s. The surface acoustic wave on the fluid is supposed to approximately 1500 m/s. Then, the fluid droplet flight angle θ is supposed to approximately 20°-30°.

According to an exemplary embodiment of the invention, the fluid injection device comprises Y—Z LiNbO₃ as piezoelectric substrate, water dye as injection fluid, and Al as slanted inter-digital electrodes. The velocity of surface acoustic wave on the Y—Z LiNbO₃ substrate is approximately 3488 m/s. If the central frequency of surface acoustic wave fluid injection device is preferably designed as 60 MHz and the bandwidth is designed as 40%, the minimum and maximum line width and interval of the slanted inter-digital electrodes are separately designed as 11.8 μm and 17.4 μm, respectively. The aperture length of the slanted inter-digital electrodes are 3000 μm and the two slanted fingers inter-digital transducers comprise 30 pairs of slanted inter-digital electrodes.

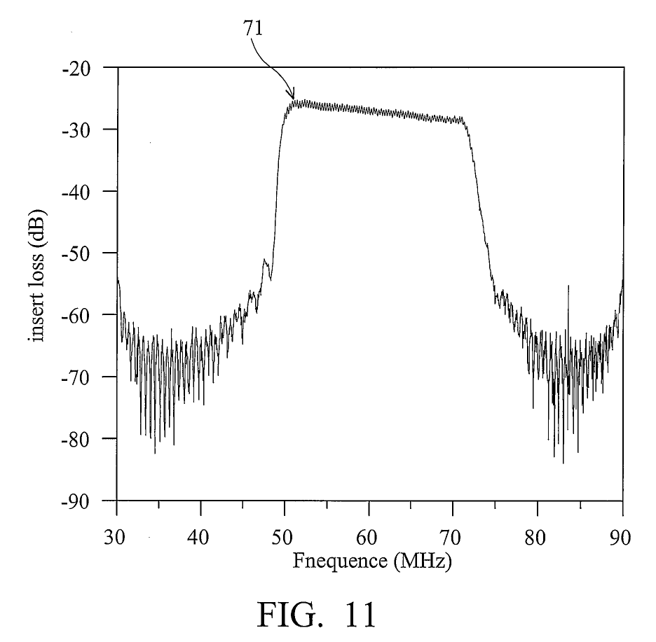

FIG. 11 shows an exemplary embodiment of a frequency response spectrum of the SFIT SAW driven fluid injection device. The frequency response spectrum 71 has a minimum frequency of 50 MHz and the maximum frequency of 74 MHz; therefore, the bandwidth of the frequency response spectrum 71 is approximately 40%. The frequency response spectrum 71 can be divided into 7 bands. Each band has 4 MHz interval increased from 50 MHz to 74 MHz. More specifically, we can input 7 AC signals with different frequencies to drive the slanted fingers inter-digital transducer; the slanted fingers inter-digital transducer can generate 7 surface acoustic waves with different frequencies to inject fluid droplets at 7 different locations. Moreover, the dimensions of the fluid droplets are approximately 3 μm in the frequency range of 50-74 MHz; that is, the dimensions of the fluid droplets are independent on the frequencies of surface acoustic waves.

The flight trajectory of the ejected droplets can be changed and controlled by adjusting the input signals on the slanted fingers inter-digital transducers. More specifically, we can apply an AC signal to the right slanted fingers inter-digital transducers to inject fluid droplets at the left location; we also can apply an AC signal to the left slanted fingers inter-digital transducers to inject fluid droplets at the right location; furthermore, we can apply two AC signals to both the slanted fingers inter-digital transducers to inject fluid droplets at a specific location.

The invention is advantageous in that fluid droplets with different locations and flight trajectories can be provided by inputting driving AC signals with different amplitudes and frequencies. More specifically, by providing multiple signals to the SFIT surface acoustic wave driven fluid injection device, more than one droplet at different locations and flight direction can be injected simultaneously without additional amplifiers or switches.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A surface acoustic wave driven fluid injection device, comprising:
a substrate;
a channel disposed in the substrate along a first direction containing a fluid which has an exposed surface; and
a first slanted fingers inter-digital transducer disposed on one side of the channel of the substrate,
wherein the first slanted fingers inter-digital transducer comprises a plurality of slanted inter-digital electrodes, and wherein the width and interval of one end of the slanted inter-digital electrodes are greater than the width and interval of the other end of the slanted inter-digital electrodes, thereby providing continuous surface acoustic wave with multiple frequencies.

2. The fluid injection device as claimed in claim 1, wherein the surface acoustic wave driven fluid injector comprises a monolithic fluid injection device.

3. The fluid injection device as claimed in claim 1, wherein the substrate comprises quartz, AlN, ZnO, LiNbO₃, Pb(ZrₓT₁₋ₓ)O₃, or other piezoelectric materials.

4. The fluid injection device as claimed in claim 1, wherein the first slanted fingers inter-digital transducer is directly disposed on the substrate.

5. The fluid injection device as claimed in claim 1, further comprising a second slanted fingers inter-digital transducer disposed on the other side of the channel of the substrate, wherein the second slanted fingers inter-digital transducer comprises a pair of slanted inter-digital electrodes, and wherein the width and interval of one end of the slanted inter-digital electrodes are greater than the width and interval of the other end of the slanted inter-digital electrodes, thereby providing continuous surface acoustic wave with multiple frequencies.

6. The fluid injection device as claimed in claim 5, wherein the distance between the first slanted fingers inter-digital transducer and the channel equals the distance between the second slanted fingers inter-digital transducer and the channel.

7. The fluid injection device as claimed in claim 5, wherein a wider electrode end of the first slanted fingers inter-digital transducer is at the same side with a wider electrode end of the second slanted fingers inter-digital transducer.

8. The fluid injection device as claimed in claim 5, wherein a wider electrode end of the first slanted fingers inter-digital transducer is at the opposite side with a wider electrode end of the second slanted fingers inter-digital transducer.

9. The fluid injection device as claimed in claim 8, wherein the distance between the narrower electrode end of the first slanted fingers inter-digital transducer and the channel equals the wider electrode end of the distance between the second slanted fingers inter-digital transducer and the channel.

10. The fluid injection device as claimed in claim 1, further comprising a piezoelectric layer interposed between the first slanted fingers inter-digital transducer and the substrate, wherein the piezoelectric layer comprises AlN, ZnO, LiNbO₃, Pb(ZrₓT₁₋ₓ)O₃, or other piezoelectric materials.

11. The fluid injection device as claimed in claim 10, further comprising a passivation layer covering the first slanted fingers inter-digital transducer, wherein the passivation layer comprises SiO₂, Si₃N₄, or other dielectric materials.

12. The fluid injection device as claimed in claim 1, further comprising a piezoelectric layer disposed on the substrate and covering the first slanted inter-digital transducer.

13. The fluid injection device as claimed in claim 12, further comprising a passivation layer covering the piezoelectric layer.

14. The fluid injection device as claimed in claim 1, further comprising a nozzle plate disposed on the channel, wherein the nozzle plate comprises a plurality of nozzles connecting to the channel.

15. A surface acoustic wave driven fluid injection device, comprising:
a piezoelectric substrate;
a channel disposed in the substrate along a first direction containing a fluid which has an exposed surface;
a first slanted fingers inter-digital transducer disposed on one side of the channel of the substrate; and
a second slanted fingers inter-digital transducer disposed on the other side of the channel of the substrate,
wherein the first slanted fingers inter-digital transducer comprises a plurality of slanted inter-digital electrodes, and wherein the width and interval of one end of the slanted inter-digital electrodes are greater than the width and the interval of the other end of the slanted inter-digital electrodes, thereby providing continuous surface acoustic wave with multiple frequencies, and
wherein the second slanted fingers inter-digital transducer comprises a plurality of slanted inter-digital electrodes, and wherein the width and interval of one end of the slanted inter-digital electrodes are greater than the width and interval of the other end of the slanted inter-digital electrodes, thereby providing continuous surface acoustic wave with multiple frequencies.

16. The fluid injection device as claimed in claim 15, wherein the distance between the first slanted fingers inter-digital transducer and the channel equals the distance between the second slanted fingers inter-digital transducer and the channel.

17. The fluid injection device as claimed in claim 15, wherein a wider electrode end of the first slanted fingers inter-digital transducer is at the opposite side with a wider electrode end of the second fingers slanted inter-digital transducer.

18. The fluid injection device as claimed in claim 17, wherein the distance between the narrower electrode end of the first slanted fingers inter-digital transducer and the channel equals the wider electrode end of the distance between the second slanted fingers inter-digital transducer and the channel.

19. The fluid injection device as claimed in claim 15, further comprising a piezoelectric layer interposed between the first and second slanted fingers inter-digital transducers and the substrate.

20. The fluid injection device as claimed in claim 19, further comprising a passivation layer covering the first and second slanted fingers inter-digital transducers, wherein the passivation layer comprises SiO₂, Si₃N₄, or other dielectric materials.

21. The fluid injection device as claimed in claim 15, further comprising a piezoelectric layer disposed on the substrate and covering the first and second slanted inter-digital transducers.

22. The fluid injection device as claimed in claim 21, further comprising a passivation layer covering the piezoelectric layer.

23. The fluid injection device as claimed in claim 15, further comprising a nozzle plate disposed on the channel, wherein the nozzle plate comprises a plurality of nozzles connecting the channel.
